(19) United States
(12) Patent Application Publication
(10) Pub. No.: US 2014/0231110 A1
(43) Pub. Date: Aug. 21, 2014

(54) SINGLE-PIECE MOLDBOARD HAVING DUALLY-ROTATED WING SECTIONS

(71) Applicant: CATERPILLAR INC., Peoria, IL (US)

(72) Inventor: Michael P. MAY, Wamego, KS (US)

(73) Assignee: CATERPILLAR INC., Peoria, IL (US)

(21) Appl. No.: 13/770,819

(22) Filed: Feb. 19, 2013

(51) Int. Cl. E02F 3/76; B23P 15/00

(52) U.S. Cl. CPC E02F 3/7613; B23P 15/00
USPC 172/815; 29/407.1; 29/428

(57) ABSTRACT

A moldboard is disclosed for use with a machine. The moldboard may have a center section that is curved about a center axis, a first wing section joined to a first side of the center section, and a second wing section joined to a second side of the center section. The first wing section may be curved about a first wing axis, and the second wing section may be curved about a second wing axis. The first and second wing axes may be rotated in at least two directions relative to the center axis.

### TECHNICAL FIELD

The present disclosure relates to a moldboard and, more particularly, to a single-piece moldboard having dually-rotated wing sections.

### BACKGROUND

Excavation machines, for example dozers and motorgraders, are commonly used in earth moving applications. These machines typically have a frame supported by one or more traction devices, and a work tool known as a moldboard movably connected to the frame. Hydraulic actuators are generally disposed between the frame and the moldboard to move, lift, rotate, and/or tilt the moldboard during operation.

Typical universal blade (U-blade) or semi-universal moldboards include a main section and opposing side or wing sections. Each section is fabricated separately from an elongated flat panel. This fabrication can include cutting of the general shape of each section from the flat panel, rolling of the cut shapes in a length direction to form matching curvatures, and welding together of the separate pieces along their matching seams. Depending on the intended machine and material application, each moldboard may have sections with different shapes, sizes, and/or radii of curvature. Accordingly, design and fabrication of a typical moldboard can be complex and labor intensive.

One attempt to improve fabrication of a moldboard is disclosed in U.S. Patent Application Publication 2008/0314607 of May that published on Dec. 25, 2008 (“the '607 publication”). Specifically, the '607 publication discloses a process for fabricating a U-blade dozer moldboard from a flat, one-piece material blank. The fabrication process involves flame-cutting two inverted V-shaped notches within a lower edge of the blank, the notches defining outer wing sections at opposing sides of a central body section. The tops of the notches define brake lines. A rolling operation is then performed to create a uniform curvature in a lower portion of the moldboard, below the brake line. Each of the wing sections are then bent approximately 30° inward towards each other. This bending step brings the opposing edges of each notch into engagement with each other. Each bend is performed in a vertical direction across a flat upper portion, about a line extending upward from the notches. Fabrication of the moldboard is finalized by welding the closed joints remaining between the moldboard wings and the center section.

While the moldboard of the '607 publication may have reduced complexity and fabrication requirements, it may still be less than optimal. Specifically, the wing sections of the moldboard described in the '607 publication are only bent (rotated) in one direction. This geometry may have limited precision, and the process of the '607 publication cannot be applied to moldboards having more complex geometry. Further, the '607 publication does not disclose how to determine geometry of the notches required to ensure that, after the bending step is complete, edges of the notches align correctly.

The present disclosure is directed to overcoming one or more of the problems set forth above and/or other problems of the prior art.

### SUMMARY

In one aspect, the present disclosure is directed to a moldboard. The moldboard may include a center section that is curved about a center axis, a first wing section connected to a first side of the center section, and a second wing section connected to a second side of the center section. The first wing section may be curved about a first wing axis, and the second wing section may be curved about a second wing axis. The first and second wing axis may be rotated in at least two directions relative to the center axis.

In another aspect, the present disclosure is directed to a method of designing a moldboard. The method may include receiving a desired radius of curvature of a center section, a first wing section, and a second wing section. The method may also include receiving a desired first rotation angle of a first wing section axis and a second wing section axis relative to a center section axis, and receiving a desired second rotation angle of the first and second wing section axes relative to the center section axis. The method may further include determining a resultant wing angle as a function of the first and second rotation angles, and determining a plurality of angles associated with intersections of the center axis, the first wing section axis, and the second wing section axis. The method may additionally include generating notch curvatures separating the center section from the first and second wing sections based on the plurality of angles.

In yet another aspect, the present disclosure is directed to a method of fabricating a moldboard. The method may include cutting a flat metal panel along notch curvatures dividing a center section from first and second wing sections. The notch curvatures may be defined at least partially by a sinusoidal curve calculated based on cylinder unwrapping equations for curvature intersection of the center section and the first and second wing sections. The method may also include rolling the center section, the first wing section, and the second wing section to form curvature in the center section and the first and second wing sections after the flat metal panel has been cut. The method may further include bending the flat metal panel along fold lines between the center section, the first wing section, and the second wing section to bring cut edges of the center section, first wing section, and second wing section together. Curvature axes of the first and second wing sections may be rotated in at least two directions relative to a curvature axis of the center section during bending of the flat metal panel. The method may further include welding the cut edges together.

### BRIEF DESCRIPTION OF THE DRAWINGS

FIG. 1 is a pictorial illustration of an exemplary disclosed machine; and

FIGS. 2-6 are diagrammatic illustrations from different viewpoints of exemplary disclosed moldboards that may be used with the machine of FIG. 1.

### DETAILED DESCRIPTION

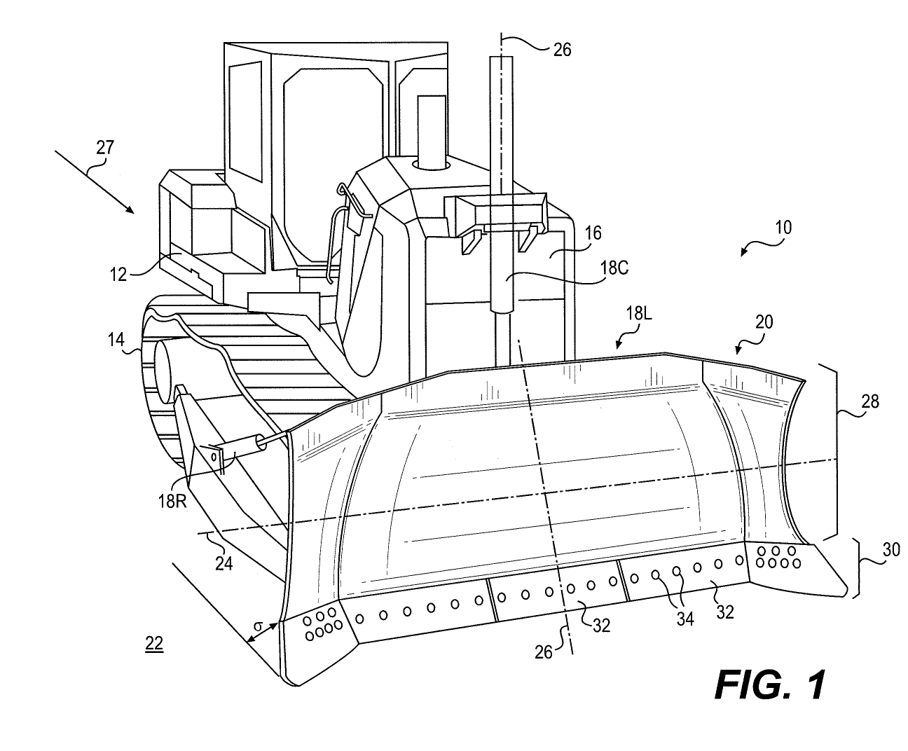

FIG. 1 illustrates an exemplary earth-moving machine 10. Machine 10 may be a mobile machine that performs some type of operation associated with an industry such as mining, construction, farming, or any other industry known in the art. In the disclosed example, machine 10 is a track-type dozer. It is contemplated, however, that machine 10 may be another type of machine, if desired. For example, machine 10 could be a wheel dozer, a motor grader, or another type of machine known in the art. Machine 10 may include, among other things, a frame 12, a plurality of traction devices 14 (e.g., tracks, belts, or wheels—only one shown in FIG. 1) configured to support frame 12, a power source 16 (e.g., an internal combustion engine) that drives traction devices 14, and one or more actuators 18 powered by power source 16 to move a moldboard 20.

In the disclosed embodiment, three different actuators 18 are used to move moldboard 20. Specifically, a center actuator 18C is shown in FIG. 1 as located at a transverse center of moldboard 20 and configured to raise and lower moldboard 20 relative to a ground surface 22. In addition, left and right actuators 18L, 18R are shown as being located at opposing sides of machine 10 and moldboard 20. Left and right actuators 18L, 18R may be used together to tilt moldboard 20 about a horizontal axis 24 or in opposition to each other to rotate moldboard 20 about a vertical axis 26. Horizontal axis 24 may be substantially orthogonal to a normal travel direction of machine 10, represented by an arrow 27, and extend transversely relative to frame 12 of machine 10. Vertical axis 26 may also be substantially orthogonal to the normal travel direction of machine 10, but also substantially orthogonal to ground surface 22. For the purposes of this disclosure, horizontal axis 24 may generally define a horizontal direction, while vertical axis 26 may generally define a vertical direction. In the depicted embodiment, actuators 18 are hydraulic cylinders powered with fluid pressurized by power source 16. It is contemplated, however, that actuators 18 could alternatively be motors or another type of actuator, if desired, and/or that actuators 18 could be pneumatically powered, electrically powered, or powered in any other manner.

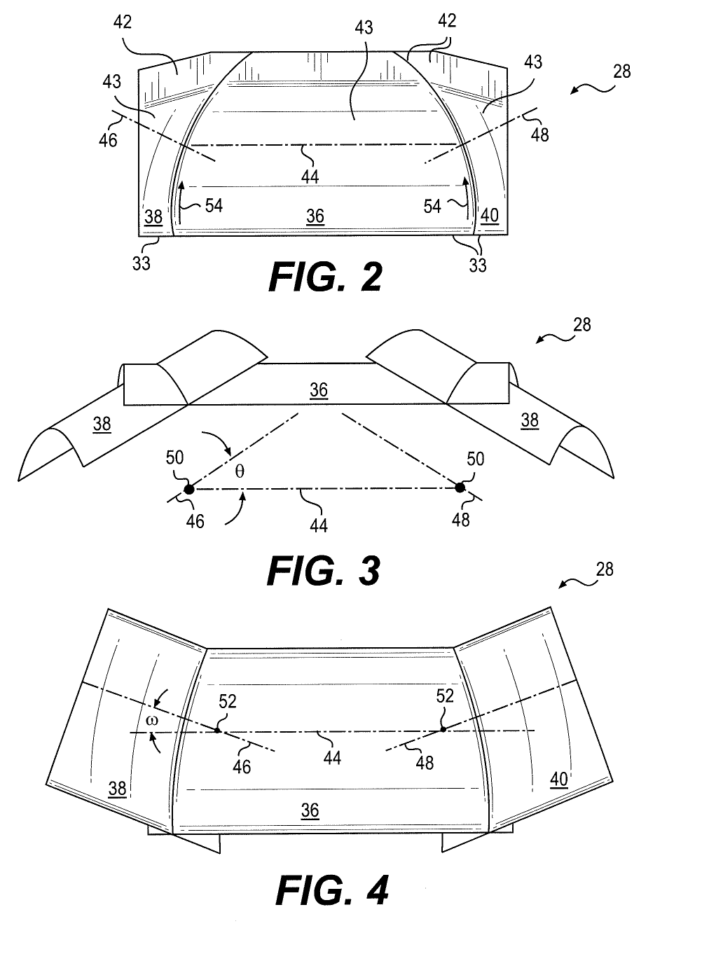

Moldboard 20 may be an assembly of components that together forms a blade, such as a generally U-shaped blade used to move ore or overburden. For example, moldboard 20 may include a body 28, and a cutting edge 30 removably connected to body 28. Cutting edge 30 may be formed by a plurality of wear members 32 that are replaceably connected to ground engaging edges 33 (shown in FIG. 2) of body 28 by way of fasteners 34. Cutting edges 30 may be configured to penetrate ground surface 22 when center actuator 18C lowers moldboard 20. During this penetration, cutting edges 30 may wear and need to be replaced periodically. Fasteners 34 may allow for removal and replacement of cutting edges 30.

As shown in FIG. 2, body 28 of moldboard 20 may be a fabrication of at least three primary components. In particular, body 28 may be fabricated from a center section 36, a first wing section 38, and a second wing section 40. First wing section 38 may be joined to center section 36 at one transverse end of center section 36, while second wing section 40 may be joined to an opposing transverse end of center section 36. As will be described in more detail below, center section 36, first wing section 38, and second wing section 40 may be joined to each other at least partially by way of welding. A push direction of moldboard 20, when moldboard 20 is connected to machine 10 (referring to FIG. 1), may be generally aligned with the travel direction (see arrow 27) of machine 10. Accordingly, the terms “travel direction” and “push direction” will be used interchangeably in this disclosure.

Center section 36 may be a shaped panel having ground engaging edge 33 at one side, a flat upper portion 42 located opposite ground engaging edge 33, and a lower portion 43 located between ground engaging edge 33 and upper portion 42. Lower portion 43 may be curved along it height (i.e., in the direction between ground engaging edge 33 and upper portion 42 that is substantially orthogonal to the push direction of moldboard 20) about a center axis 44. Center axis 44 may be generally aligned with horizontal axis 24 (referring to FIG. 1) when moldboard 20 is attached to machine 10, while upper portion 42 may have a generally flat material-engaging surface that is tilted forward from and generally transversely aligned with vertical axis 26 (i.e., tilted forward by about 35° from vertical axis 26 in the push direction of moldboard 20). A radius of curvature of lower portion 43 may be about 1000-3000 mm (e.g., about 2000 mm). When moldboard 20 is connected to machine 10 and lowered into engagement with ground surface 22 (referring to FIG. 1), a tangent to the curvature of lower portion 43 at ground engaging edge 33 may form an interior angle α with ground surface 22 that is about 40-60° (e.g., about 55°). An overall height of center section 36, a width of center section 36, a height of upper portion 42, and a height of lower portion 43 may be dependent upon an intended application of moldboard 20. In general, a ratio of the height of upper portion 42 relative to the overall height of center section 36 may be 0-0.25.

First and second wing sections 38, 40 may be substantially identical mirror images of each other, and similar to center section 36. Specifically, each of first and second wing sections 38, 40 may be a shaped panel having ground engaging edge 33 at one side, upper portion 42 located opposite ground engaging edge 33, and lower portion 43 located between ground engaging edge 33 and upper portion 42. In the disclosed embodiment, lower portions 43 of first and second wing sections 38, 40 may have the same curvature as lower portion 43 of center section 36 and a tangent to the curvature of lower portions 43 of first and second wing sections 38, 40 may similarly form the interior angle α. It is contemplated, however, that the curvature of first and/or second wing sections 38, 40 may be different from the curvature of center section 36, if desired, and/or that the curvature of any one or more of these sections may form a different interior angle, if desired.

Although similar in contour, first and second wing sections 38, 40 may be connected to center section 36 in an advantageous orientation. Specifically, lower portion 43 of first wing section 38 may be curved about a first wing axis 46, while lower portion 43 of second wing portion 40 may be curved about a second wing axis 48. And first and second wing axes 46, 48 may not be aligned with center axis 44. For the purposes of illustrating the orientation of first and second wing axes 46, 48 relative to center axis 44, each of center, first wing, and second wing sections 36, 38, 40 are displayed generically as intersecting cylindrical surfaces in FIGS. 3 and 4 (i.e., without upper portions 42 shown and with these sections extending through the intersections without having been trimmed).

As can be seen in the top view of moldboard 20 in FIG. 3 (i.e., a view looking downward toward ground surface 22 along vertical axis 26—referring to FIG. 1), first and second wing sections 38, 40 may be rotated inward toward a middle of center section 36 such that outer edges of first and second wing sections 38, 40 are brought closer to each other. This rotation may occur about corresponding vertical axis 50, which are generally aligned with vertical axis 26, and form an interior angle θ between center axis 44 and each of first and second wing axes 46, 48. In the exemplary embodiment, θ may be about 10-40° (e.g., about 30°).

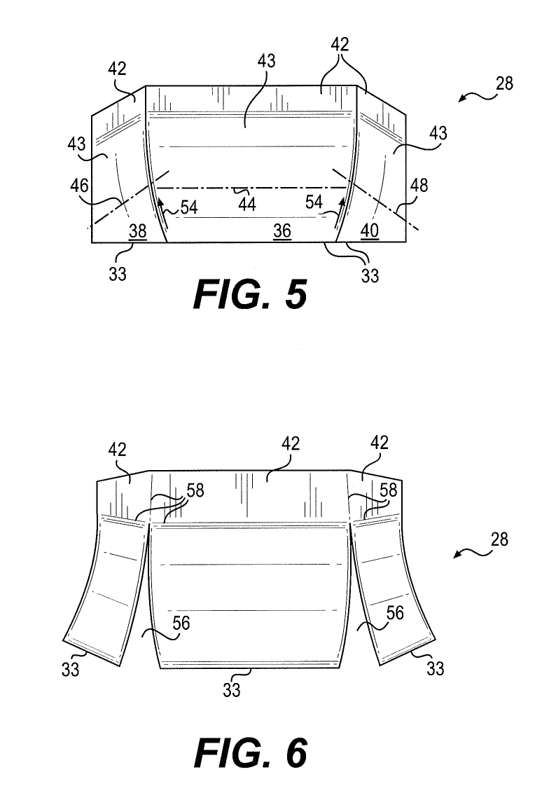

As can be seen in the front view of moldboard 20 in FIG. 4 (i.e., a view looking inward toward machine 10 in a direction opposite to the travel direction represented by arrow 27—referring to FIG. 1), first and second wing sections 38, 40 may also be rotated in opposing directions about corresponding horizontal axis 52, which are generally aligned with the push direction of moldboard 20. In the embodiment shown in FIGS. 2 and 4, upper portions 42 of first and second wing sections 38, 40 are rotated inward about horizontal axis 52 to be closer to each other. However, as shown in an alternative embodiment of FIG. 5, upper portions 42 of first and second wing sections 38, 40 are rotated outward about horizontal axis 52 to be further away from each other. In both embodiments, this rotation may form an interior angle ω that is about (−30°)−0°-(+30°) (i.e., 0° to ±30°).

The rotations of first and second wing sections 38, 40 relative to center section 36 may create some unique relationships that provide advantages to moldboard 20. For example, a blade rotation ratio of first and second wing sections 38, 40 in the first direction may be about 0.005-0.02 (i.e., a ratio of angle θ to curvature radius=10°−40°/2000 mm). Similarly, a blade rotation ratio of first and second wing sections 38, 40 in the second direction may be about 0-0.015 (i.e., a ratio of angle ω to curvature radius=0°−30°/2000 mm). In another example, a multi-direction rotation ratio of first and second wing portions 38, 40 may be about 0 to 3 (i.e., a ratio of angle ω to angle θ=0 θ/40° to 30°/10°. These unique parametric relationships may help to improve material flow across moldboard 20.

The rotations of first and second wing sections 38, 40 about horizontal axis 52 may have several different effects on the way that machine 10 engages ground surface 22 (referring to FIG. 1) and moves removed material. In particular, a length of ground engaging edge 33 of first and second wing sections 38, 40 and a length of upper portion 42 may change depending on the rotation direction and magnitude of first and second wing sections 38, 40 about horizontal axis 52. For example, as shown in FIG. 2, when upper portions 42 of first and second wing sections 38, 40 are rotated inward toward each other, the length of ground engaging edge 33 at first and second wing sections 38, 40 may be reduced, while the length of upper portions 42 may be increased. In contrast, as shown in the embodiment of FIG. 5, when upper portions 42 of first and second wing sections 38, 40 are rotated outward away from each other, the length of ground engaging edge 33 may be increased, while the length of upper portion 42 may be decreased. In general, a reduction in the length of ground engaging edge 33 may result in an increased cutting force of ground engaging edge 33, while an increase of upper portion 42 may result in a greater ability to push removed material and/or greater control over movement of the material. The opposite may also be true.

The different lengths of ground engaging edges 33 at first and second wing sections 38, 40 relative to the length of ground engaging surface 33 at center section 36 may also create some unique relationships that provide advantages to moldboard 20. For example, a ratio of the length of ground engaging surface 33 at first wing section 38 (and/or second wing surface 40) relative to the length of ground engaging surface 33 at center section 36 (i.e., a base ratio) may be about 0.1-0.5. Similarly, a ratio of the length of ground engaging surface 33 at first wing section 38 (and/or second wing surface 40) relative to the height of center section 36 (i.e., a base to height ratio) may be about 0.1-0.5. These unique parametric relationships may help to improve a cutting ability of moldboard 20.

In addition, the movement of material may generally follow the intersections of first and second wing sections 38, 40 with center section 36. And as shown in FIG. 2, when upper portions 42 of first and second wing sections 38, 40 are rotated inward toward each other, the flow of material (represented by arrows 54) may likewise be generally inward as it is pushed up the height of moldboard 20. In contrast, as shown in the embodiment of FIG. 5, when upper portions of first and second wing sections 38, 40 are rotated outward away from each other, the flow of material may likewise be generally outward as it is pushed up the height of moldboard 20. Depending on the application of machine 10, these material flow directions may be desirable in different situations.

Regardless of the rotation directions of first and second wing sections 38, 40, ground engaging edges 33 of all sections 36-40 may be configured to engage ground surface 22 (referring to FIG. 1) in a consistent and even manner. That is, ground engaging surfaces 33 of all sections 36-40 may generally lie within a common plane that is substantially aligned with ground surface 22.

In the exemplary embodiment shown in FIG. 6, moldboard 20 may be fabricated from a flat single-piece blank of metal. In particular, a curved notch 56 may be formed (e.g., flame cut and/or stamped) within the blank to separate first and second wing sections 38, 40 from center section 36 (i.e., to at least partially define inner boundaries of all sections 36-40). In this example, upper portions 42 may remain integral and connected with each other throughout fabrication, and notches 56 may extend only from ground engaging edge 33 to upper portions 42. After fabrication of notches 56, the curvatures of center, first wing, and second wing sections 36, 38, 40 may then be created through a single roll-forming process or through multiple separate roll-forming processes, as required. The blank of metal may then be bent along a plurality of fold lines 58, until the inner boundaries at opposing ends of center section 36 engage the inner boundaries of first and second wing sections 38, 40. In the disclosed embodiment, the fold lines 58 separating upper portions 42 from each other may be generally vertically-oriented fold lines that are substantially tangent with respect to the curves at the top of the notches in a single-piece blank. The engaged inner boundaries may be welded together following the bending process.

Design of moldboard 20 (e.g., generation of the curvatures of notches 56 and/or the locations and orientations of fold lines 58) is, in itself, a unique process. Description of this process will be provided in more detail in the following section to further illustrate the disclosed concepts.

### INDUSTRIAL APPLICABILITY

The disclosed moldboard may be applicable to any machine where improved function, durability, and cost are desired. The disclosed moldboard may have improved function through the use of unique geometric configurations achieved through parametric curve relationships that enable the blade cutting force and material flow to be tailored to specific worksite conditions and/or intended applications. The disclosed moldboard may have improved durability due to its fabrication from a single-piece blank of metal. The disclosed moldboard may have improved cost through a unique design process, which will be described in more detail below, that reduces an overall design time and streamlines the fabrication process.

Design of a new moldboard 20 may begin with receipt of desired moldboard dimensions. These desired moldboard dimensions may include, for example, a desired radius of curvature r of center section 36, which should correspond to the radius of curvature of first wing section 38 and second wing section 40. The desired moldboard dimensions may also include a desired value for first rotation angle θ and a desired value for second rotation angle ω. These values may be determined by a potential owner and/or worksite manager of machine 10, and correspond with an intended application of machine 10. For example, in applications where the material to be moved by machine 10 is generally loose (e.g., wood chips or piled coal), ground penetration may not be the most important factor. In these applications, a smaller positive angle ω (and/or a greater negative angle ω) may be desired. In contrast, in applications where greater ground penetration is desired (e.g., in applications involving hard-packed overburden), a larger positive angle ω may be desired.

After receiving the desired values for rotation angles θ and ω, a plurality of angles associated with intersections of center axis 44, first wing axis 46, and second wing axis 48 may then be determined. These angles may include, among others, a resultant (i.e., compound) angle λ between center axis 44 and first wing axis 46. Angle λ may be determined using the law of cosines, based on the received values for θ and ω, in two consecutive applications. Once angle λ is determined, a resultant tilt angle δ of first wing axis 46 may then be determined with respect to center axis 44. Angle δ may be determined as a function of angle λ (e.g., δ=λ−180°. The next step may be to determine an angle σ between a horizontal plane of first wing section 38 (e.g., a plane formed by center and first wing axes 44, 46) and a global horizontal plane of moldboard 20 (e.g., a plane substantially parallel with ground surface 22 when moldboard 20 is assembled to machine 10). Angle σ may be based on the second direction of wing rotation ω designed to efficiently push material. Angle β, designated as the angle of intersection between a radius of center section 36 and a radius of first wing section 38, may then be determined as a function of the resultant tilt angle δ (e.g., β=δ−90). An angle α, which may determine the rotation of cut between center section 36 and first and second wing sections 38, 40, may then be determined as a function of σ (e.g., α=σ+35°).

Once these angles (and others) have been determined, three different cylinder unwrapping curves may be generated that can be used to create moldboard 20. The first cylinder unwrapping curve may be a sinusoidal curve generated by means of EQ 1 below that is subsequently used create one side of notch 56. The second cylinder unwrapping curve may also be a sinusoidal curve, and generated by means of EQ 2 below that is subsequently used to create outer geometry of moldboard 20 (i.e., the side and lower boundaries of moldboard 20). The third cylinder unwrapping curve may be generated by means of EQ 3 below and is subsequently used to create fold lines 58 between the different upper portions 42.

Notch Curvature=\sqrt{{r²−(r*sin [(x+rα)/r]²}}*(secβ+tan β)−r*tan β EQ 1
wherein:
   r is the radius of curvature of center, first wing, and second wing sections 36, 38, 40;
   x is the horizontal length of the notch curve as it is unwrapped onto the flat metal blank to produce the flat state of the curve;
   α is the angle lying between the first wing horizontal plane and a plane perpendicular to upper portion 42; and
β is about equal to 90°—the angle of intersection of between a radius of center section 36 and a radius of first wing section 38.

Curves for Outer and Bottom Edges=−tan β*[r sin(x/r)*cos α+\sqrt{r²−r sin(x/r)²}*sin α] EQ 2
wherein:
   r is the radius of curvature of center, first wing, and second wing sections 36, 38, 40;
   x is the horizontal length of the notch curve as it is unwrapped onto the flat metal blank to produce the flat state of the curve;
   α is the angle lying between the first wing horizontal plane and a plane perpendicular to upper portion 42; and
   β is about equal to 90°-the angle of intersection of between a radius of center section 36 and a radius of first wing section 38.

Fold Line Angle=(sec β+tan β)*(−sin α) EQ 3
wherein:
   α is the angle lying between the first wing horizontal plane and a plane perpendicular to upper portion 42; and
   β is about equal to 90°—the angle of intersection of between a radius of center section 36 and a radius of first wing section 38.

Once the first sinusoidal curve has been generated using EQ 1 described above, the curve may be mirrored across fold line 58 of upper sections 42 (i.e., across the fold line angle found using EQ 3) to generate a paired sinusoidal curve used to form the opposite side of the same notch 56. These cylinder unwrapping curves, once determined via EQs. 1-3 described above, may then be plotted on the blank of metal used to fabricate moldboard 20, and the notches, boundary edges, and fold lines formed.

It will be apparent to those skilled in the art that various modifications and variations can be made to the disclosed moldboard. Other embodiments will be apparent to those skilled in the art from consideration of the specification and practice of the disclosed moldboard. It is intended that the specification and examples be considered as exemplary only, with a true scope being indicated by the following claims and their equivalents.

What is claimed is:

1. A moldboard, comprising:
a center section being curved about a center axis;
a first wing section joined to a first end of the center section, the first wing section being curved about a first wing axis; and
a second wing section joined to a second end of the center section, the second wing section being curved about a second wing axis,
wherein the first and second wing axes are rotated in at least two directions relative to the center axis.

2. The moldboard of claim 1, wherein the center section, first wing section, and second wing section are fabricated from a single piece blank of metal and remain connected throughout fabrication.

3. The moldboard of claim 1, wherein:
the center section, the first wing section, and the second wing section each include an upper portion and a lower portion;
the upper portions of the center section, the first wing section, and the second wing section are generally flat and integral with each other; and
the lower portions of the center section, the first wing section, and the second wing sections are connected to each other via welding after being rolled and bent.

4. The moldboard of claim 3, wherein the upper portions of the center section, the first wing section, and the second wing section each have a flat material engagement surface that is oriented in a generally vertical direction substantially orthogonal to and tilted forward in a push direction of the moldboard.

5. The moldboard of claim 4, wherein the flat material engagement surfaces of the center, first wing, and second wing sections are joined at fold lines oriented in the generally vertical direction.

6. The moldboard of claim 1, wherein the first and second wing sections are mirror images of each other.

7. The moldboard of claim 1, wherein a radius of curvature of the center section is about equal to a radius of curvature of each of the first and second wing sections.

8. The moldboard of claim 7, wherein the radius of curvature of the center, the first wing, and the second wing sections is about 1000-3000 mm.

9. The moldboard of claim 1, wherein rotation in the at least two directions includes:
rotation in a first direction inward toward the center section about a first rotation axis that is substantially orthogonal to the center axis and orthogonal to a push direction of the moldboard; and
rotation in a second direction about a second rotation axis that is substantially orthogonal to the center axis and aligned with the push direction of the moldboard.

10. The moldboard of claim 9, wherein:
each of the first and second wing sections includes a ground engaging edge and an opposing upper portion; and
the rotation in the second direction rotates the upper portions of the first and second wing sections towards each other.

11. The moldboard of claim 9, wherein:
each of the first and second wing sections includes a ground engaging edge and an opposing upper portion; and
the rotation in the second direction rotates the upper portions of the first and second wing sections away from each other.

12. The moldboard of claim 9, wherein:
rotation in the second direction includes rotation through an angle of about −30° to 30°; and
rotation in the first direction includes rotation through an angle of about 10° to 40°.

13. The moldboard of claim 9, wherein a blade rotation ratio of the first and second wing sections in the first direction is about 0.005-0.02.

14. The moldboard of claim 9, wherein a blade rotation ratio of the first and second wing sections in the second direction is about 0-0.015.

15. The moldboard of claim 9, wherein a multi-direction rotation ratio of the first and second wing sections is about 0-3.

16. The moldboard of claim 1, wherein:
each of the center, first wing, and second wing sections includes a ground engaging edge and an opposing flat upper portion; and
the ground engaging edge forms an interior angle with a ground surface of about 55° when the moldboard is connected to a machine.

17. The moldboard of claim 16, wherein the ground engaging edges of the center, first wing, and second wing sections all lie in a common plane.

18. The moldboard of claim 1, wherein a base ratio of the first wing section is about 0.1-0.5.

19. The moldboard of claim 1, wherein a base to height ratio of the first wing section is about 0.1-0.5.

20. The moldboard of claim 1, wherein:
each of the center, first wing, and second wing sections includes a ground engaging edge and an opposing upper edge; and
material being pushed by the moldboard at the ground engaging edge is directed by the first and second wing sections inward toward a middle of the center section.

21. The moldboard of claim 1, wherein:
each of the center, first wing, and second wing sections includes a ground engaging edge and an opposing upper edge; and
material being pushed by the moldboard at the ground engaging edge is directed by the first and second wing sections outward away from a middle of the center section.

22. A method of designing a moldboard, comprising:
receiving a desired radius of curvature of a center section, a first wing section, and a second wing section;
receiving a desired first rotation angle of a first wing section axis and a second wing section axis relative to a center section axis;
receiving a desired second rotation angle of the first and second wing section axes relative to the center section axis;
determining a resultant wing angle as a function of the desired first and second rotation angles;
determining a plurality of angles associated with intersections of the center section axis, the first wing section axis, and the second wing section axis; and
generating notch curvatures separating the center section from the first and second wing sections based on the plurality of angles.

23. The method of claim 22, wherein generating the notch curvatures includes generating a first sinusoidal curve that separates each of the first and second wing sections from the center section.

24. The method of claim 23, wherein generating the notch curvatures further includes mirroring the first sinusoidal curve across fold lines that separates each of the first and second wing sections from the center section.

25. The method of claim 23, wherein generating the first sinusoidal curve includes generating the first sinusoidal curve based on a cylinder unwrapping equation for curvature intersection of the center section and the first and second wing sections.

26. The method of claim 25, further including generating a second sinusoidal curve based on a cylinder unwrapping equation for an intersection of a plane and curvatures of the first and second wing sections, the second sinusoidal curve defining outer boundaries of the first and second wing sections.

27. A method of fabricating a moldboard, comprising:
cutting a flat metal panel along notch curvatures dividing a center section from first and second wing sections, the notch curvatures being defined at least partially by a sinusoidal curve calculated based on cylinder unwrapping equations for a curvature intersection of the center section and the first and second wing sections;
rolling the center section, the first wing section, and the second wing section to form curvature in the center section and the first and second wing sections after the flat metal panel has been cut;
bending the flat metal panel along fold lines between the center section, the first wing section, and the second wing section to bring cut edges of the center section, first wing section, and second wing section together, wherein curvature axes of the first and second wing sections are rotated in at least two directions relative to a curvature axis of the center section during bending of the flat metal panel; and
welding the cut edges together.
